(19) United States
(12) Patent Application Publication
(10) Pub. No.: US 2007/0294860 A1
(43) Pub. Date: Dec. 27, 2007

(54) VEHICLE DOOR HINGE

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: NEW LIGHT, LLC, Portland, OR (US)

(21) Appl. No.: 11/767,470

(22) Filed: Jun. 22, 2007

Related U.S. Application Data
(60) Provisional application No. 60/805,565, filed on Jun. 22, 2006.

(51) Int. Cl. E05D 15/00

(52) U.S. Cl. 16/368

(57) ABSTRACT

A hinge for vehicle doors so as to provide for door front edge opening operation, also known as suicide operation, comprises fastening elements provided with fixed pivot pins and with sliding guides, which can be housed respectively in the thickness of the door and in a corresponding pillar; linkages for connecting the fastening elements with their first extremity, hinged on the fixed pivot pin of one of the fastening elements and with a second extremity including a shoe engaged in the sliding guide of the other fastening element; and a joint interposed at the extremities of the linkages which pivotally couples the linkages to each other allowing their relative angular mobility. The fastening elements further comprise a control means in cooperative engagement with the sliding guide and shoe for adjustably controlling the maximum range of rotation of the hinge.

### RELATED APPLICATIONS

This is a nonprovisional application claiming priority to U.S. provisional patent application No. 60/805,565, filed on Jun. 22, 2006, entitled Automobile Door Hinge, which is in its entirety incorporated herewith by reference.

### FIELD OF THE INVENTION

This invention relates to vehicle doors, and more particularly, to a door hinge and methods for operation.

### BACKGROUND OF INVENTION

It is well known in motor vehicles to have two front door openings for a two-door vehicle, and two front door openings and two rear door openings for a four-door vehicle, which are respectively closed by separate front and rear doors. Conventional car doors are typically hinged at the front-facing edge of the door and allow the door to swing outward opening rearward from the body of the car.

Suicide doors are automobile doors that are hinged on the rear-facing edge of the door, that is, the edge closer to the back of the vehicle. The name refers to the perceived greater danger of such a door falling open at speed. Such doors were commonly seen on cars manufactured in the first half of the 20th century. Post-World War II examples are almost universally the rear doors of four-door cars. The last true, independently opening suicide doors were fitted to the 1971 Ford Thunderbird, after which their use ceased due to safety concerns. More recently, rear suicide doors that cannot be opened until the conventional front doors are open have been used on a number of vehicles

Suicide doors are popular with after market, custom car, and hot rod enthusiasts. It would, therefore, be highly desirable to have components and assemblies that provide automobile manufacturers, aftermarket and hot rod enthusiasts the ability to incorporate suicide door operation in currently designed automobiles without major modification to the automobile body or door structures.

### BRIEF DESCRIPTION OF DRAWINGS

FIG. 1 is a perspective view of a two-door automobile having doors operable in the door front edge opening, or suicide, configuration, in accordance with an embodiment of the present invention;

FIG. 2 is a perspective view of a two-door automobile with the door removed for clarity, operable in the door front edge opening, or suicide, configuration, in accordance with an embodiment of the present invention;

FIG. 3 is a perspective view of a door for closing the door opening and operable in the door front edge opening, or suicide, configuration includes a door rear edge and a door front edge, in accordance with an embodiment of the present invention;

FIGS. 4, 5, and 6 are perspective and cross-sectional views of a hinge in accordance with an embodiment of the present invention;

FIG. 7 is a cross-sectional view of another hinge in accordance with an embodiment of the present invention; and

FIG. 8 is a side perspective view of a door opening, in accordance with the present invention.

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

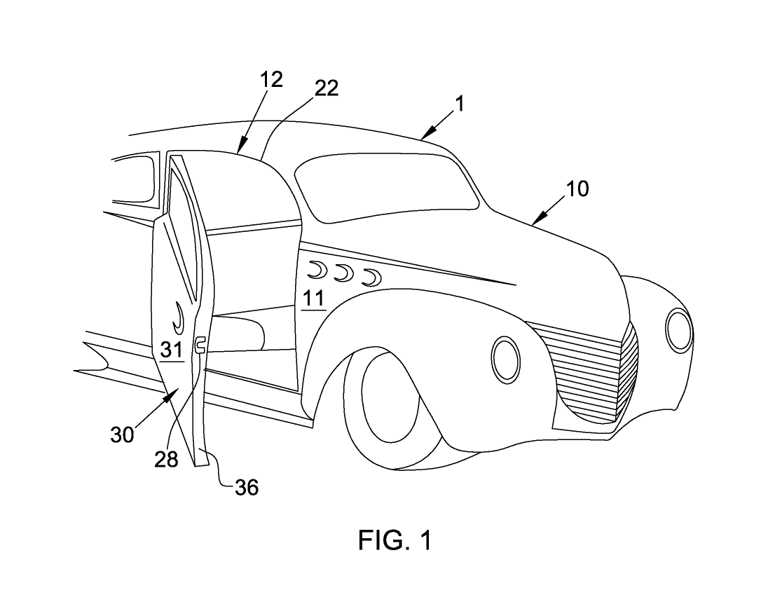

FIG. 1 is a perspective view of a two-door automobile 1 having doors 30 operable in the door front edge opening, or suicide, configuration, in accordance with an embodiment of the present invention. The following description will refer to the two-door automobile but it is appreciated that embodiments of the present invention are also suitable for four-door automobiles and doors for other vehicles.

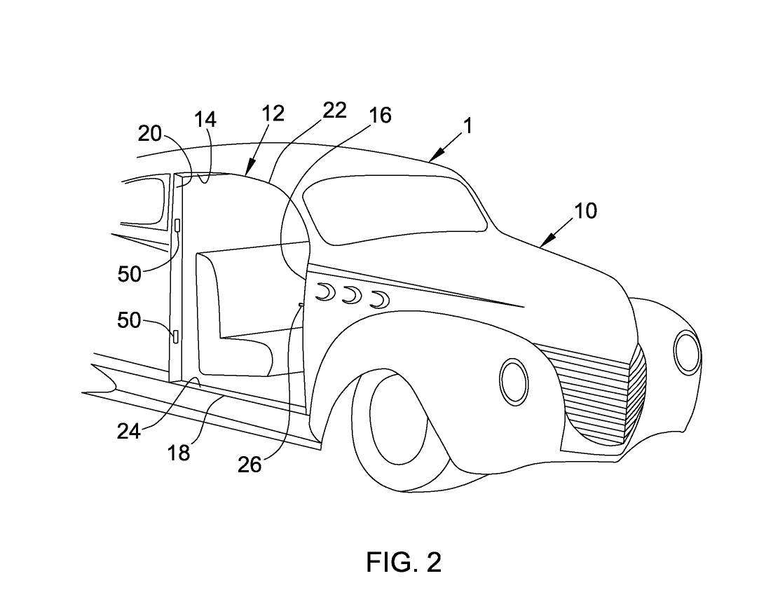

FIG. 2 is a perspective view of the two-door automobile 1 with the door 30 removed for clarity, operable in the door front edge opening, or suicide, configuration, in accordance with an embodiment of the present invention. Referring to FIGS. 1 and 2, a vehicle body 10 includes a front door opening 12. The front door opening 12 is defined by a front pillar 16 and a rear pillar 20. The upper edge 14 of the door opening 12 is defined by a roof header 22 and the bottom edge 18 is defined by a rocker panel 24.

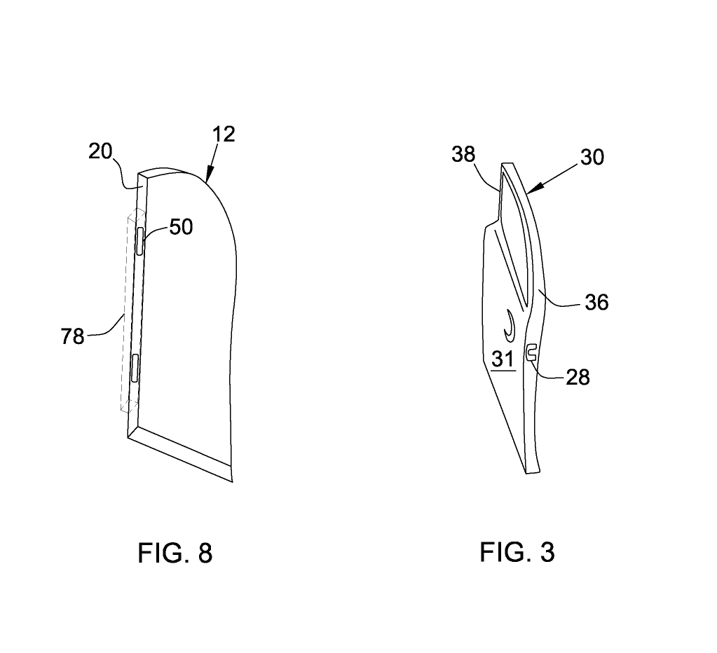

FIG. 3 is a perspective view of a door 30 for closing the door opening 12 and operable in the door front edge opening, or suicide, configuration, in accordance with an embodiment of the present invention. The door 30 includes a door rear edge 38 and a door front edge 36. The door rear edge 38 is hinged to the rear pillar 20 by one or more hinges 50. The hinge 50 suitable for the particular purpose and in accordance with the present invention is described below.

Referring to the door 30 and the front door opening 12, a door latch 28 is mounted on the door front edge 36 and may be a particular door latch suitable for the particular purpose. A striker 26 is mounted on the front pillar 16 facing the front opening 12 and may be a particular striker suitable for the particular purpose. The door latch 28 receives the striker 26 when the door 30 is in the closed position to latch and secure the door 30 in the closed position. In the closed position, the striker 26 is captured within the door latch 28 to maintain the door 30 in the closed position. It is appreciated that the striker 26 and door latch 28 may be switched in position. It is also appreciated that any suitable closure mechanism may be used for securing the door 30 in the closed position.

The door 30 is moved from the closed position to the open position by actuating the door latch 28 to release the striker 26. The door front edge 36 is pushed outwardly via a handle (not shown). The door 30 is adapted to swing outwardly until it reaches the desired open position shown in FIG. 1.

Various types of hinges may be used to couple the door 30 to the rear pillar 20, but in particular, a hidden hinge as described in accordance with the present invention is particularly suited for the purpose. The hinge of the present invention is partly contained inside the thickness of the door 30 and partly inside the thickness of the rear pillar 20 and comprises in particular two fastening elements adapted to couple the hinge respectively to the door 30 and to the rear pillar 20; linkages, each of which is connected to the two fastening elements with their first extremity hinged on a fixed pivot pin of one of the fastening elements and with the other extremity engaged in a sliding guide borne by the other fastening element; and a pivot pin, interposed at the extremities of the linkages, which connects the linkages in mutually pivoting fashion being able to move, remaining parallel to itself, in the opening and closing motion of the door 30. The hinge further comprises a maximum opening controlling means for controlling the extent of rotation of the hinge.

In practice, the hinge allows for the door 30 to be opened at an angle of 180 degrees, the maximum extent of rotation controlled by the maximum opening controlling means. Depending on the installation, the hinge 50 is controlled to open less than 180 degrees. In one embodiment, the maximum opening controlling means is a non-adjustable feature of the hinge 50. In other embodiments, the maximum opening controlling means is user adjustable providing one of a range of opening angles suitable for a particular purpose.

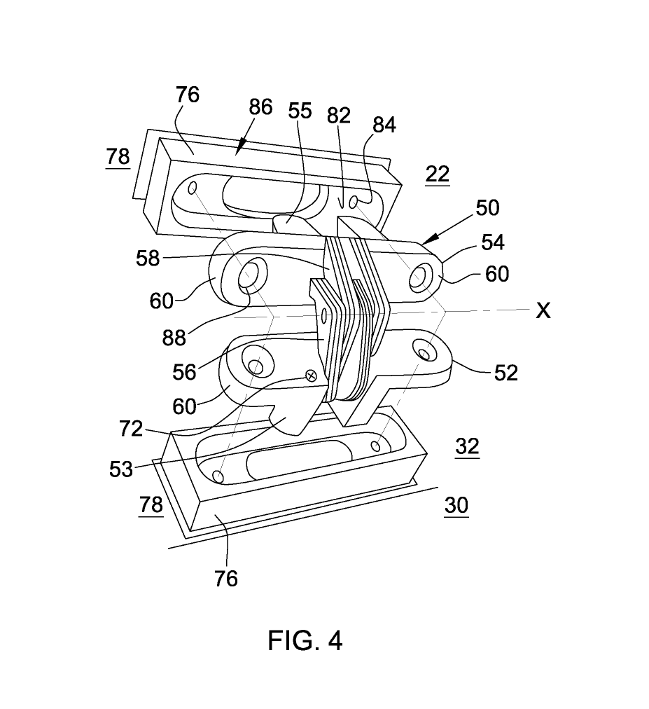

FIGS. 4, 5, and 6 are perspective and cross-sectional views of the hinge 50 in accordance with an embodiment of the present invention. The hinge 50 comprises a first fastening element 52 and a second fastening element 54, adapted to be coupled to the door 30 and to the rear pillar 20, and first linkage 56 and second linkage 58 which, advantageously articulated to each other and to the fastening elements 52, 54, allow to couple the door 30 pivotally to the rear pillar 20, as is necessary for the related opening and closing. The fastening elements 52, 54 are embodied by corresponding internally hollow bodies 53, 55, preferably made of metallic material and provided with planar flanges 60. The bodies 53, 55 are housed in the thickness of the door rear edge 38 and of either the middle pillar 18 or the rear pillar 20 and in the closed condition of the door 30 they are substantially mutually opposed and aligned at some angle .alpha. of zero or greater.

Each of the bodies 53, 55 is internally provided with a fixed pivot pin 62 and with a sliding guide 64. The pivot pin 62 is oriented parallel to a first direction X shown in FIG. 4 and that is orthogonal to the view shown in FIG. 5. The sliding guides 64 are instead rectilinear and oriented orthogonal to the pivot pins 62.

Each linkage 56, 58 is coupled to both fastening elements 52, 54. More in particular, a first extremity 57 of each linkage 56, 58 is hinged on the fixed pivot pin 62 of one of the fastening elements 52, 54, and the second extremity 59, which is provided with a shoe 66, is engaged in the sliding guide 64 of the other fastening element 52, 54.

The two linkages 56, 58 are mutually connected in pivoting fashion by a joint 68 situated between the related extremities 57, 59.

The linkages 56, 58 generally have elongated, globally curvilinear shapes, substantially similar in design and dimensions, devised to allow, when installed on a vehicle as shown in FIG. 1, the door 30 to rotate relative to the rear pillar 20 between two extreme positions: in the first whereof, the door 30 is closed and aligned with its own door exterior face 31 to the outer surface 11 of the automobile shown in FIG. 1; in the second position the door 30 being open and the door front edge 36 swung away from the automobile body 10.

More specifically, defining as a first linkage portion 63 that part of the linkages 56, 58 that is situated between the first extremity 57 and the joint 68 and as a second linkage portion 65 that part that is situated between the joint 68 and the second extremity 59, wherein the two linkages 56, 58 have mutually the same lengths, both in correspondence with their first linkage portions 63, and in correspondence with their second linkage portions 65.

The hinge 50 is advantageously constructed in such a way as to be also adjustable in range of rotation according to the spatial direction .alpha. and upon the activation of related adjustment means 70.

Referring to FIG. 6, in accordance with an embodiment of the present invention, the adjustment means 70 comprises a set screw 72 adapted for operable engagement with a threaded bore 74 extending from the hinge front 51 and in operable alignment with the sliding guide 64. The set screw 72 extends into the sliding guide 64 so as to engage the shoe 66 slidingly engaged with the sliding guide 64 so as to limit the maximum extent of translation of the shoe 66 within the sliding guide 64 controlling the angle .alpha. in which the hinge 50 opens. Rotation of the set screw 72 in a first direction extends the set screw 72 further into operable engagement with the sliding guide 64, further restricting the range of motion of the shoe 66 and thus the range of rotation of the hinge 50. Rotation of the set screw 72 in a second direction opposite the first direction backs out the set screw 72 from the sliding guide 64, allowing for a greater range of motion of the shoe 66 and thus the range of rotation of the hinge 50. In this arrangement, the extent of the range of opening .alpha. of the hinge 50 is adjustable to an opening angle of substantially 180 degrees or less. This is desirable, such as, but not limited to, such that in the open position, the door does not impact an adjacent object, and such that in the open position, the door is easily reached for closing. The set screw 72 is accessible and adjustable from the hinge front 51 and as such is adjustable while the hinge 50 is installed in the automobile. It is appreciated that the adjustment means 70 provided above may be provided in either or both of the bodies 53, 55.

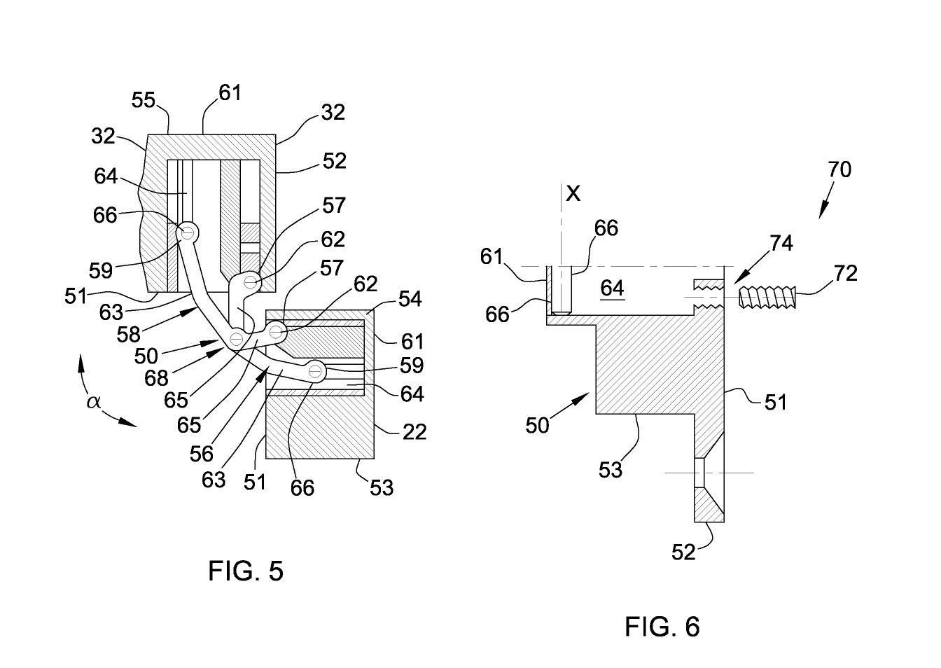

FIG. 7 is a cross-sectional view of hinge 50 in accordance with another embodiment of the present invention, including an adjustment means 70 comprising a set screw 72 adapted for operable engagement with a threaded bore 74 extending from the hinge rear 61 and in operable alignment with the sliding guide 64. The set screw 72 engages the shoe 66 slidingly engaged with the sliding guide 64 so as to limit the extent of translation of the shoe 66 within the sliding guide 64 controlling the angle .alpha. in which the hinge 50 closes. Rotation of the set screw 72 in a first direction extends the set screw 72 further into operable engagement with the sliding guide 64, further restricting the range of motion of the shoe 66 and thus the range of rotation of the hinge 50. Rotation of the set screw 72 in a second direction opposite the first direction backs out the set screw 72 from the sliding guide 64, allowing for a greater range of motion of the shoe 66 and thus the range of rotation of the hinge 50. In this arrangement, the extent of the range of closing of the hinge 50 is limited and adjustable to a closing angle of substantially zero degrees or more. This is desirable, such as, but not limited to, such that in the closed position, the door may be aligned with the outer surface of the automobile. It is appreciated that the adjustment means 70 provided above may be provided in either or both of the bodies 53, 55.

In the above embodiments, the adjustment means 70 comprises a set screw 72. It is understood and appreciated that other elements providing similar function can be used to control the range of motion of the hinge 50, that is, adjustable in range of rotation according to the spatial direction .alpha.. Any element suitable for engagement of the shoe 66 that is slidingly engaged with the sliding guide 64 is appreciated so as to limit the maximum extent of translation of the shoe 66 within the sliding guide 64 controlling the angle .alpha. in which the hinge 50 opens and/or closes. Suitable elements include, but not limited to, pins, posts, and detent means, whether user adjustable or not.

It is appreciated that the adjustment means 70 provided above may be provided by a number of other embodiments suitable for the particular purpose, such as, but not limited to an insert secured into a bore by a locking means. In another embodiment in accordance with the present invention, the adjustment means 70 comprises a peg and receiving bore. The peg and receiving bore comprise complimentary locking features, such as, but not limited to, ridge/seat rings, adapted to cooperate to provide a removable coupling between the peg and bore. A plurality of pegs of different lengths may be provided in a kit allowing the installer to select the peg of suitable length to provide a predetermined pivot adjustment.

In another embodiment in accordance with the present invention, the adjustment means 70 comprises a peg having detents adapted to engage longitudinal channels formed in the bore to permit selective rotation and extension of the peg with respect to the bore.

Referring again to FIG. 4, the hinge 50 further comprises reinforcement inserts 76 in accordance with an embodiment of the present invention. The reinforcement inserts 76 are coupled to and provide additional support material to reinforce either the rear pillar 20 and/or the door rear edge 38. The reinforcement inserts 76 are particularly advantageous wherein the rear pillar 20 and/or the door rear edge 38 has insufficient strength and stiffness to support the loads on the hinges 50. In accordance with an embodiment of the present invention, the reinforcement inserts 76 comprise a recess portion 82 adapted to receive one of the bodies 53, 55 therein and an exterior surface 86 suitable for coupling to the respective rear pillar 20 or the door rear edge 38. The recess portion 82 further comprises suitable fastener receiving elements 84 coaxially aligned with corresponding fastener apertures 88 in the flange 60 of the fastening element 52 adapted to receive a suitable fastener (not shown) so as to couple the fastening element 52 to the reinforcement insert 76.

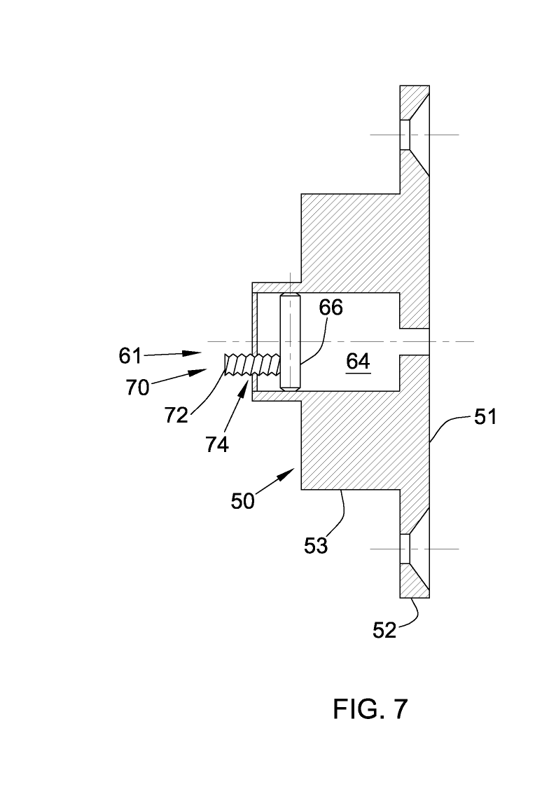

FIG. 8 is a side perspective view of the door opening 12, in accordance with the present invention. The rear pillar 20 is provided with a box beam 78 to provide structural support to the respective elements as needed to support the loading on the hinges 50. Referring also to FIG. 4, the reinforcement inserts 76 may be coupled to the box beam 78 or recessed into the box beam 78 suitable for a particular purpose. Similarly, the rear door edge 38 may be provided with a box beam 78 to provide structural support.

Thus, it is seen that the invention provides a suicide-type door operation by which the door front edge swings away from the vehicle body.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed:

1. A hinge, in particular for vehicle doors having a door front edge and a door rear edge, the hinge adapted to provide door front edge opening operation, comprising:
at least two fastening elements, each provided with a fixed pivot pin, a sliding guide and flanges, adapted to be coupled respectively to the door rear edge and a corresponding fixed pillar;
linkages each having a first and second extremity which are coupled to the fastening elements respectively with their first extremity hinged on the fixed pivot pin of one of the fastening elements and with a second extremity engaged in the sliding guide of another fastening element, the second extremity including a shoe adapted for sliding engagement within the sliding guide; and
a joint interposed between the extremities of the linkages which pivotally couples the linkages to each other allowing their relative angular mobility, wherein the maximum range of rotation of the hinge is controlled by a control means in cooperative engagement with the sliding guide and shoe.

2. The hinge of claim 1, wherein the control means comprises a set screw engaged in a threaded bore aligned and in cooperative engagement with the sliding guide and shoe so as to provide adjustability of the limit the opening range of the hinge by the extend of advancement of the set screw within the threaded bore with abutment of the set screw with the shoe.

3. The hinge of claim 1, wherein the control means comprises a peg engaged in a bore aligned and in cooperative engagement with the sliding guide and shoe, the peg and bore comprising locking means for removably coupling the peg to the bore, so as to provide adjustability of the limit the opening range of the hinge by the extend of advancement of the peg within the bore with abutment of the peg with the shoe.

4. The hinge of claim 1, wherein the linkages are dimensioned and shaped to allow the rotation of the door relative to the rear pillar between two extreme conditions, in one of which the door is closed and aligned with an exterior face thereof to a surface of the automobile and in the second condition the door front edge being open and positioned away from the automobile body.

5. A hinge, in particular for vehicle doors, to provide door front edge opening operation, comprising:
a first and second fastening element each provided with a fixed pivot pin and a sliding guide;
linkages each having a first and second extremity for coupling the first and second fastening elements respectively with the first extremity hinged on the fixed pivot pin of one of the fastening elements and with the second extremity engaged in the sliding guide of the other fastening element, the second extremity including a shoe adapted for sliding engagement within the sliding guide;
a joint interposed between the extremities of the linkages which pivotally couples the linkages to each other allowing their relative angular mobility; and
an adjustable control means operatively engaged with the sliding guide and shoe so as to control the maximum range of rotation of the hinge.

6. The hinge of claim 5, wherein the control means comprises a set screw engaged in a threaded bore aligned and in cooperative engagement with the sliding guide and shoe so as to provide adjustability of the limit of the opening range of the hinge by the extend of advancement of the set screw within the threaded bore with abutment of the set screw with the shoe.

7. The hinge of claim 6, wherein the linkages are dimensioned and shaped to allow the rotation of a door relative to a rear pillar between two extreme positions, in one of which the door is closed and aligned with an exterior surface of an automobile and in a second position the door being open and swung away from the exterior surface of the automobile.

8. The hinge of claim 6, wherein the hinge further comprises reinforcement inserts each comprising a recess portion adapted to receive one of the fastening elements therein, the recess portion further comprising fastener receiving elements coaxially aligned with corresponding fastener apertures in the fastening element adapted to receive a suitable fastener so as to couple the fastening element to the reinforcement insert.

9. A hinge, in particular for vehicle doors, to provide door front edge opening operation, comprising:
at least two fastening elements each provided with a fixed pivot pin and with a sliding guide;
a first and second linkage each having a first and second extremity coupled to the fastening elements respectively with their first extremity hinged on the fixed pivot pin of one of the fastening elements and with a second extremity engaged in the sliding guide of the other fastening element, the second extremity including a shoe adapted for sliding engagement within the sliding guide;
a joint interposed between the extremities of the linkages which pivotally connects the linkages to each other allowing their relative angular mobility; and
an adjustable control means operatively engaged with the sliding guide and shoe so as to control the maximum range of rotation of the hinge.

10. A hinge, in particular for a vehicle to provide door front edge opening operation, the automobile having a rear pillar and a door, comprising:
a first fastening element and a second fastening element each adapted to be coupled to either of the door and the rear pillar;
a first linkage and second linkage advantageously articulated to each other and to the fastening elements, the fastening elements are embodied by corresponding internally hollow bodies and provided with planar flanges, each of the bodies is internally provided with a fixed pivot pin and with a sliding guide, the pivot pin oriented parallel to a first direction, the sliding guides are rectilinear and oriented orthogonal to the first direction;
each linkage comprises a first extremity hinged on the fixed pivot pin of one of the first and second fastening elements, and a second extremity, which is provided with a shoe, engaged in the sliding guide of the other of the first and second fastening element, the two linkages are mutually coupled in pivoting fashion by a joint disposed between the respective extremities, the linkages generally having an elongated, globally curvilinear shape, substantially similar in design and dimensions, operatively related to rotate between an open and closed position, wherein the linkages comprise a first linkage portion disposed between the first extremity and the joint and as a second linkage portion disposed between the joint and the second extremity, wherein the two linkages have mutually the same lengths, both in correspondence with their first linkage portions, and in correspondence with their second linkage portions; and
an adjustment means in operable engagement with the shoe so as to limit the range of rotation of the hinge.

11. The hinge of claim 10 wherein the adjustment means comprises a set screw adapted for operable engagement with a threaded bore extending from a hinge front and in operable alignment with the sliding guide, the set screw extending into the sliding guide so as to engage the shoe so as to limit the maximum extent of translation of the shoe within the sliding guide controlling the angle in which the hinge opens, wherein rotation of the set screw in a first direction extends the set screw further into operable engagement with the sliding guide restricting the range of motion of the shoe and thus the range of rotation of the hinge, and wherein rotation of the set screw in a second direction opposite the first direction backs out the set screw from the sliding guide allowing for a greater range of motion of the shoe and thus the range of rotation of the hinge.

12. The hinge of claim 10 wherein the adjustment means comprising a set screw adapted for operable engagement with a threaded bore extending from a hinge rear and in operable alignment with the sliding guide, the set screw adapted to engage the shoe slidingly engaged with the sliding guide so as to limit the extent of translation of the shoe within the sliding guide controlling the angle in which the hinge closes, wherein rotation of the set screw in a first direction extends the set screw further into operable engagement with the sliding guide restricting the range of motion of the shoe and thus the range of rotation of the hinge, and wherein rotation of the set screw in a second direction opposite the first direction backs out the set screw from the sliding guide allowing for a greater range of motion of the shoe and thus the range of rotation of the hinge.

13. The hinge of claim 10 further comprising reinforcement inserts each comprising a recess portion adapted to receive one of the fastening elements therein, the recess portion further comprising fastener receiving elements coaxially aligned with corresponding fastener apertures of the fastening element adapted to receive a suitable fastener so as to couple the fastening element to the reinforcement insert.
